(19) United States
(12) Patent Application Publication
(10) Pub. No.: US 2002/0080950 A1
(43) Pub. Date: Jun. 27, 2002

(54) Method and system for monitoring service transactions

(75) Inventors: John R. Koko, Louisville, KY (US); Lawrence M. Pensack, Louisville, KY (US); Larry T. Sutherland, Louisville, KY (US); Clifton F. Crawford, Louisville, KY (US); Michael D. Wood, Louisville, KY (US); Steven H. Levy, Louisville, KY (US); William C. Murray, Louisville, KY (US); Salah Boukadoum, Dallas, TX (US)

Correspondence Address: Keiko Ichiye, Baker Botts L.L.P., 2001 Ross Avenue, Dallas, TX, 75201, US

(73) Assignee: Stratos Group, Ltd.;

(21) Appl. No.: 09/746,299

(22) Filed: Dec. 21, 2000

(51) Int. Cl. H04M 3/00

(52) U.S. Cl. 379/265.06

(57) ABSTRACT

A system and method for monitoring a service transaction are disclosed. A client communicates through a communication channel. Feedback is gathered from the client through the communication channel. The feedback describes an agent and an interaction associated with the agent, and is stored in a client response database.

### TECHNICAL FIELD OF THE INVENTION

This invention relates generally to the field of providing professional services and more specifically to a method and system for monitoring service transactions.

### BACKGROUND OF THE INVENTION

The potential for problems arising from an interaction between an agent and a client has led to a need for a method and system for monitoring agent-client interactions. Many agent-client interactions involve discussions on which the client bases important decisions. For example, insurance agents describe the benefits and limitations of insurance policies to potential clients. Home service and repair agents, for example, pest control, plumbing, and installation agents, explain services and costs. Medical doctors, attorneys, and stockbrokers also discuss information on which a client relies to make important decisions.

In these situations, problems may arise from the agent-client interaction. An agent may unintentionally misinform a client. Or, an agent may take advantage of a client by, for example, misleading the client about the benefits of the offered service. Conversely, a client may falsely accuse an agent of improper behavior. To avoid these problems, agent-client interactions may be monitored. One type of known method for monitoring the actions of agents involves sending out a questionnaire or telephoning a client after an agent-client interaction. These known methods for monitoring the actions of agents, however, have not been satisfactory with respect to efficiency and effectiveness.

### SUMMARY OF THE INVENTION

In accordance with the present invention, a method and system for monitoring service transactions are provided that substantially eliminate or reduce the disadvantages and problems associated with previously developed systems and methods.

According to one embodiment of the present invention, a method for monitoring a service transaction is disclosed. A client communicates through a communication channel. Feedback is gathered from the client through the communication channel. The feedback describes an agent and an interaction associated with the agent, and is stored in a client response database.

According to one embodiment of the present invention, a system for monitoring a service transaction is disclosed. A communication channel communicates feedback from a client. The feedback describes an interaction between an agent and the client. A monitoring module initiates collection of the feedback, receives the feedback from the communication channel, and- stores the feedback in a client record database.

A technical advantage of one embodiment of the present invention is that it automatically gathers and evaluates client feedback about agent-client interactions. The feedback may be used to build a client record documenting the client's understanding of the agent-client interaction, which may be useful in defending a company against the client's later allegations. The client feedback may also be used to effectively match a client with an appropriate agent. The client feedback may also be used to provide a current assessment of the risks posed by an agent and to determine a premium payment to insure the agent for future transactions. An assessment of the profitability and effectiveness of the agent may also be determined from the client feedback.

Another technical advantage of the present invention is that it may be used to certify a company to indicate to consumers that the company's agents are being monitored and that clients have a communication channel through which to provide feedback about the agents.

Other technical advantages are readily apparent to one skilled in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 is a block diagram of one embodiment of a system for monitoring transactions that may be used in accordance with the present invention; and

FIG. 2 is a flowchart demonstrating one embodiment of a method for monitoring transactions that may be used in accordance with the present invention.

### DETAILED DESCRIPTION OF THE DRAWINGS

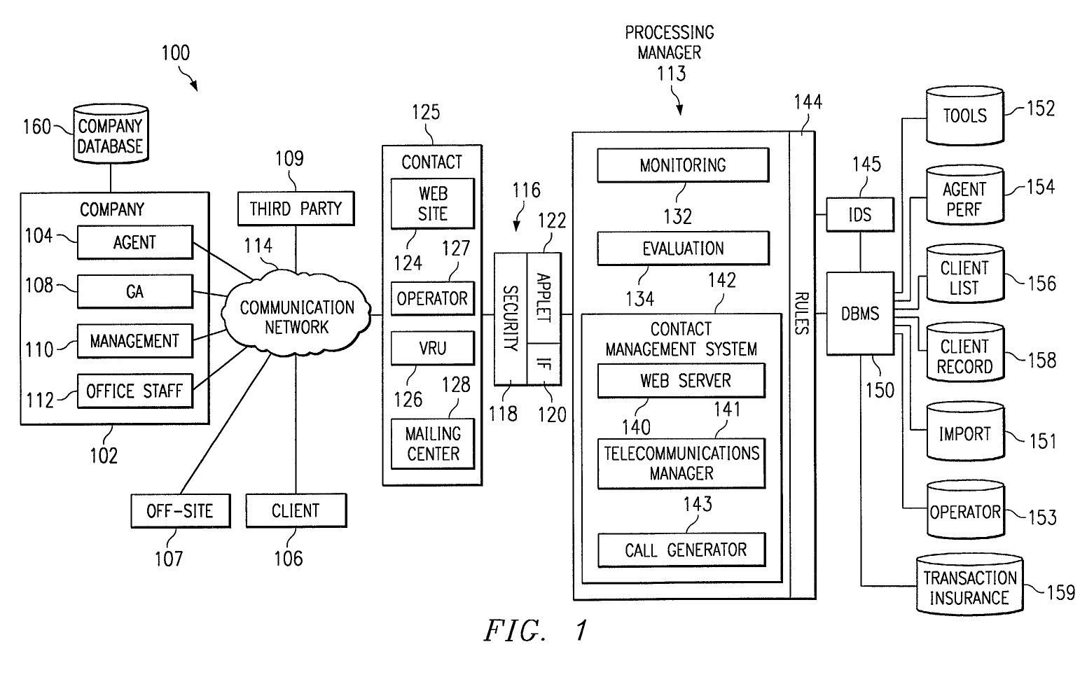

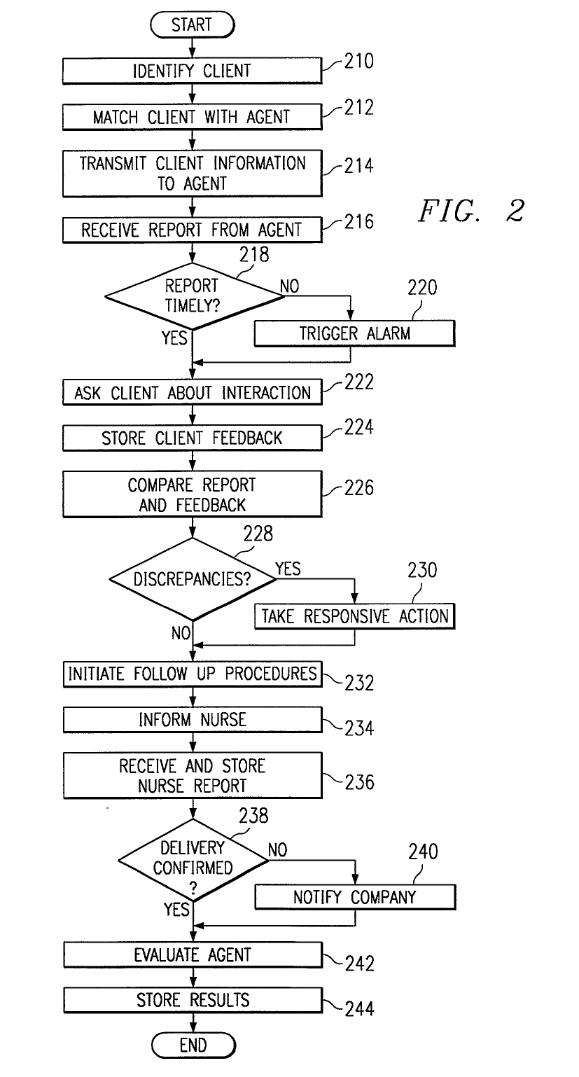

An embodiment of the present invention and its advantages are best understood by referring to FIGS. 1-2 of the drawings, like numerals being used for like and corresponding parts of the various drawings.

FIG. 1 is a block diagram of one embodiment of a system 100 for monitoring transactions in accordance with the present invention. According to one embodiment, system 100 establishes communication channels with the client to gather feedback about the agent from the client. Using the gathered feedback, system 100 monitors and evaluates the performance of the agent and builds a record of the agent-client interaction. The evaluation information may be used to generate a list of agents who may be effectively matched with the proper clients. The evaluation information may also be used to assess the risk posed by the agent's actions to determine premium payments for insurance associated with transactions conducted by the agent.

Referring to FIG. 1, system 100 includes a company 102 with an agent 104 who interacts with a client 106 System 100 also includes a processing manager 113 that monitors and evaluates agent 104's interaction with client 106. The operations of system 100 may be conducted using software, hardware, human resources, or any combination of the preceding.

Agent 104 may be, for example, an employee or representative of company 102 such as a sales representative, a health maintenance organization physician, or an insurance agent. Client 106 may be, for example, a patient, client, or customer of company 102. Agent 104 may interact with client 106 by communicating information about company 102 or a product or service provided by company 102 to client 106. Company 102 may also includes a general administrator (GA) 108, a management division 110, and an office staff 112. Company 102 may also have a company database 160 where company stores information relating to, for example, its agents 104, clients 106, and policies. Company database 160 may be a database of an external entity that stores information for company 102.

The communication of information between client 106, agent 104, and/or processing manager 113 may occur, for example, in person or through a communication network 114 and a contact module 125. For example, company 102 may provide data from company database 160 to processing manager 113 through contact module 125. Client 106 may use contact module 125 to collect information about company 102 or to provide feedback about an interaction with agent 104.

Communication network 114 may include wired telecommunications, satellite, microwave, or other suitable wireline or wireless networks, or a combination of the preceding. Contact module 125 may provide communication via, for example, email, written communication, text telecommunication such as live chat over Internet Protocol, voice telecommunication such as voice over Internet Protocol, or other suitable method of communication such as video telecommunication or in person communication.

Contact module 125 may include a website 124, a voice response unit (VRU) 126, an operator 127, a mailing center 128, and/or other suitable communication module. Website 124 provides online communication such as webpages or live chat communication. Voice response unit 126 may provide automated responses to input signal from a telecommunications device. Operators 127 may provide text or voice telecommunication. Mailing center 128 may include a mail room that handles written communication.

Interface module 116 associated with contact module 125 may include a security module 118, a hypertext markup language (HTML) interface (IF) 120, and applets 122. Security module 118 may provide, for example, password security, resource access security, and/or system security. HTML interface 120 provides instructions to a web browser on how to display a website.

Applets 122 may include software applications that may run on a user's browser or computer. Examples of applets 122 include a live chat applet that allows users to communicate in real time, a rate calculator that allows a user to estimate a premium for an insurance policy, and an eligibility calculator that allows a user to determine eligibility for an insurance policy. Interface module 116 may also provide files to a user's browser or computer. For example, interface module 116 may deliver a Microsoft PowerPoint presentation to agent 104's laptop.

Other entities, for example, a user at an off-site location 107 or a third party 109 may communicate through contact module 125. A user at an off-site location may include, for example, agent 104 working from home or presenting a seminar in a hotel conference room. A third party may include, for example, a credit check company or fraud control service that may be used to verify client 106, a location provider website that may be used to provide maps to agent 104, or a lead generation service that may provide leads for potential clients 106.

Agent 104 may access the services provided by processing manager 113 through a wired or wireless communication link to a portal of website 124. Other suitable methods may be used, for example, agent 104 may place a telephone call to operator 127 or voice response unit 126. Alternatively, agent 104 may replicate needed information from contact module 125 and periodically synchronize and update data using, for example, Microsoft Exchange or Lotus Notes applications. Agent 104 may also have these services installed on his laptop.

Processing manager 113 processes data gathered from company 102, agent 104, and client 106, and stores data in and retrieves data from a database management system (DBMS) 150 such as Microsoft Structured Query Language (SQL) server. In one embodiment, databases may include, but are not limited to, a tools database 152, an agent performance database 154, a client list 156, a client record 158, an import database 151, an operator database 153, and a transaction insurance database 159.

Databases 152 to 159 may store text data, scanned information, video and audio data, applications, applets and/or other data. Text data may be stored in an HTML format and indexed for retrieval by database management system 150. Documents may be scanned, compressed, and indexed for storage. Video and audio communication may be recorded, digitally compressed, and indexed for storage. Video and audio files may be compressed and indexed. These files may be communicated to users using an online presentation application, such as Flash, or a streamlining audio/video application, such as Yahoo Broadcast. Applications and applets may also be compressed and indexed, and delivered to users though contact module 125.

Tools database 152 includes information used by agent 104, GA 108, management 110, office staff 112, and/or contact module 127. Tools database 152 may include text data, for example, scripts that agent 104 or operator 127 may use to describe an insurance policy or to gather feedback about an agent-client interaction. The scripts may be customized for each potential client by, for example, filling the name of the potential client in the appropriate places within a script that can be read during contact with client 106.

In one embodiment, tools database 152 may also include a quote engine that agent 104 or operator 127 may use to give client 106 an estimated premium payment for an insurance policy. The quote engine may take the form of an applet that retrieves policy information from import database 151 and client information from client record database 158 to generate a quote. The quote engine may be included in a script presented to operator 127. To generate a quote for a caller, operator may activate a “quote” button shown on the script.

Maps may be included to show agent 104 the directions to the residence of client 106. The maps may be provided by a location provider website. Tools database 152 may also provide information retrieved from company database 160. For example, a preferred providers list may be included so client 106 may determine whether his healthcare provider is covered under a policy. The list may be updated with information from the import database 151.

Additionally, training tools may be included in tools database 152. Training tools may include seminars or videos that may be presented on-site or may be communicated to another site, and that may be used to train new agents or operators or to help agents improve their agent-client interaction. Tools database 152 may also include marketing materials, for example, a seminar for introducing potential clients to the insurance policies or information on purchasing company logo products.

In one embodiment, agent performance database 154 may include information describing and evaluating the agent 104's performance. The information may include, for example, a ranking of all the agents with respect to each other, feedback from client 106, and descriptions of the agent 104's performance. For example, the information may include whether an agent has been sued for malpractice. Information may also include agent 104's geographic location, tenure, professional certifications, record of complaints filed against him, outstanding debt to company 102, policy renewal rate, and adherence to the policies of company 102.

Client list database 156 may include a list of potential clients and a list of current clients. These lists may be generated from information gathered through contact module 125 from company 102, website 124, voice response unit 126, operator 127, or third party 109 lead providers. To generate the lists, an applet may present a form to client 106 or operator 127, who completes the form with client information. The form is then transmitted to client list database 156.

Client record database 158 includes information documenting interactions with client 106. This information may include, for example, documents signed by client 106 or a record of communication such as telephone calls, website activity, and live chats between client 106 and contact module 125. Information may track client preferences, referral information, other products purchased by client 106, and how long client 106 has been a customer.

An operator database 153 may store the identification of operators 127 who are currently operating. Programs that may be needed to access and import data from company database 160 may be stored in an import database 151. Import database may also store data received from company database 160.

A transaction insurance database 159 stores data relating to insuring service transactions. For example, transaction insurance database 159 may store a table listing types of transactions and their associated premiums to ensure each transaction. The table may be adjusted for particular agents or types of agents. For example, a more experienced agent may have a lower premium than a less experienced agent. Transaction insurance database 159 may also store a list of agents who cannot be insured, such as agents who have had sanctions placed against them.

Processing manager 113 may directly access databases 152 to 159, or an information delivery system (IDS) 145 may process data from databases 152 to 159 before it is delivered to processing manager 113. Information delivery system 145 may customize a form, for example, a script from tools database 152, by filling in blank fields of the form with the appropriate information, for example, client 106's personal information, before the script is delivered to agent 104, operator 127, or voice response unit 126. Applets may also be customized. For example, a quote engine that generates an estimated premium for a policy may include policy information from company database 160.

To perform customization, information delivery system 145 receives the item to be customized, determines the blank fields that need data, and retrieves that data to insert in the blank fields. The data may be retrieved from a database, for example, client 106's personal information from client record database 158, or from a module of processing manager 113. For example, information delivery system 145 may customize a script to be read to client 106 by inserting the names of three agents 104 best matched with client 106 as determined by evaluation module 134.

According to one embodiment of the present invention, processing manager 113 includes, but is not limited to, the following modules used to monitor and evaluate agent 104. A monitoring module 132 collects information from client 106 about his interaction with agent 104. The information may be gathered through contact module 125. Monitoring module 132 may use tools from tools database 152 to collect the information. For example, operator 127 may use a script from tool database 152 to gather feedback from client 106, and may use a client list from client list database 156 to determine which clients to contact to request feedback. Monitoring module 132 may store the record of interactions of client 106 in client record database 158. Client record database 158 documents client 106's understanding of the agent-client interaction, and may be useful in defending company 102 against later allegations made by client 106.

Monitoring module 132 may also compare feedback gathered from client 106 with reports from agent 104 to check that client 106 has understood the transaction and that agent 104 has correctly reported the situation. Agent 104 may be required to submit a disposition report after interacting with client 106. The disposition report may include items that agent 104 is required to answer, for example, items describing whether client 106 was satisfied with the interaction and whether client 106 purchased a policy.

Client 106 may be asked to respond to corresponding items, for example, items describing whether client 106 was satisfied with the interaction and whether client 106 purchased a policy. The items may be weighted according to importance. For example, it is more important for agent 104 and client 106 to agree on whether client 106 purchased a policy than whether client 106 was satisfied with the interaction.

Monitoring module 132 compares the values of corresponding items from the disposition report and the client feedback to determine whether client 106 has understood the transaction and agent 104 has correctly reported the situation. The weight of the items and size of discrepancies may be used to perform an effective comparison. Monitoring module 132 may also generate a report documenting the comparison.

Monitoring module 132 may also directly monitor agent 104. Agent 104's interactions with processing manager 113 may be recorded. Monitoring module 132 may receive and store agent 104's email messages and monitor the stored messages, or may monitor agent 104's email messages directly from the email program used by contact module 125. Agent 104's geographic position may be tracked using a global positioning system monitoring device on agent 104's agent appliance, for example, a laptop.

Monitoring module 132 may detect a trigger event indicating that agent 104 has committed an act that may require a responsive action. For example, client 106 may report in the feedback to monitoring module that agent 104 has assaulted him. An agent disposition report and client feedback collected by monitoring module 132 may disagree on the question of whether client 106 has purchased a policy. Agent 104 may have failed to timely submit required disposition reports to monitoring module 132 after receiving an assignment to visit client 106. Alternatively, agent 104's geographic position may be tracked by monitoring module 132 to a location far from where agent 104 should be.

In response to the trigger event, monitoring module 132 may perform a responsive action. For example, a designated person of management 110 of company 104 may be notified of agent 104's action. Monitoring module 132 may communicate a message to company database 160 to stop payment of a commission to agent 104 or to place a particular policy on hold. Third party 109 lead generator may be notified to stop giving new clients to agent 104. Evaluation module 134 may modify a premium payment for insuring a transaction involving agent 104.

An evaluation module 134 uses information gathered by monitoring module 132 to evaluate the performance of agent 104 and generate an agent profile, which may be stored in agent performance database 154. An agent profile may include client evaluations of agent 104, manager evaluations, the agent's availability, experience, training, probation, location, or other suitable criteria that may be used to describe agent 104.

Evaluation module 134 may compare the agent profile with a client profile to generate a list of agents that are effectively matched with the client. For example, a highly litigious client may be matched with the agent with the best client evaluations. A client profile may include, for example, a client's history of litigation, potential to purchase a policy, or other suitable criteria that may be used to describe client 106.

To make the comparison, the agent evaluation may include items for which agent 104 is ranked or given a numerical value, for example, success rate, customer satisfaction, and geographic location. The client description may include corresponding items for which client 106 is ranked or given a numerical value, for example, potential ease of sale, history of past complaints, and geographic location. The values of corresponding items from the agent evaluation and client description are compared to determine compatibility.

Additionally, agents 104 may be categorized and ranked in groups in order to be matched with clients 106. For example, agents 104 may be categorized by the type of product they sell, such as life insurance and health insurance, and then ranked within the groups. The rankings are then used to match agents 104 with clients 106.

The matching also take into account special situations. For example, a new agent may not have a high ranking on the list because he has not had the time and the experience to sell many policies. In order to give the new agent effective training, the new agent may be given more or better clients than his ranking would otherwise allow him. Additionally, an agent who is suffering from a personal difficulty or a health problem may be given better clients than would normally be allowed. To account for these special circumstances, an agent evaluation may include items that may be given a value to adjust agent 104's overall ranking.

A contact management system 142 manages contact module 125, and may include a webserver 140, a telecommunications manager 141, and a call generator 143. Contact management system 142 retrieves data from database management system 150 or customized data from information delivery system 145 for use by webserver 140, voice response unit 126, or operator 127. Webserver 140 maintains website 124. Webserver 140 may, for example, allow client 106 access to the preferred providers list from tools database 152. Webserver 140 may also be associated with interface module 116 to provide access and security to processing manager 113.

Telecommunications manager 141 manages the interaction between operator 127 and voice response unit 126 and a telecommunications switch in order to control communication of information between a caller processing manager 113. For example, telecommunications manager 141 may identify incoming calls using automatic number identification (ANI) to check whether a caller is providing the correct information. This may be used to prevent providing information to a competitor who pretends to be client 106. The ANI may also be used to retrieve information about a customer, such as previous purchases, to provide to operator 127.

Telecommunications manager 141 may also track the dial-in-number that client 106 called, which may be used to provide marketing information. Telecommunications manager 141 may also allow operator 127 and voice response unit 126 access a client list from client list database 156, and may also determine which operators 127 are present and communicate this information to operator database 153.

Scripts may be customized according to the caller. Contact management system 142 may use the ANI or the dial-in-number to identify a particular script to retrieve from tools database 152. Alternatively, voice response unit 126 or operator 127 may ask a caller certain qualifying questions or for a promotion code. A particular script is selected according to the callers responses.

Call generator 143 places telephone calls for operators 127 and voice response unit 126 by automatically dialing a telephone number for a given list. The list may include, for example, a client list retrieved from client list database 156, a client lead list generated by a third party 109, or a list of clients with expired policies retrieved from company database 160. The list may include a clients who request call backs.

Rules 144 organize the flow of information through processing manager 113. Rules 144 may be used to control access to the modules and may be used to update the information gathered by the modules. For example, an agent 104 who has not promptly completed required administrative work may not have access to new leads for clients 106. Rules may also be used to specify call routing. For example, if client 106 makes over a certain number of complaints, the next call from client 106 is automatically routed to manager 110. Rules may also specify types of requests for data retrieved directly from database management system 150 or for customized data received though information delivery system 145.

In operation, monitoring module 132 monitors agent 104 by monitoring agent 104's activities and by gathering feedback from client 106 through contact module 125. The gathered information may be stored in client record database 158. Evaluation module 134 receives the information collected by monitoring module 132 and evaluates agent 104's performance to generate a list of agents matched to a client. The results of the evaluation are stored in agent performance database 154. In one embodiment, system 100 constantly updates the data in the databases to provide current information for more accurate evaluation of agent 104's risk.

FIG. 2 is a flowchart of one embodiment of a method for monitoring a service transaction. The method provides a standardized procedure for monitoring agent 104's interactions with client 106, which may eliminate or manage problems arising from agent 104's actions. The method also evaluates the agents of company 102 in order to effectively match agents and clients, which may avoid potential problems arising from the interaction. Additionally, the method may be used to create a record of client 106's understanding of the interaction, which may be useful in defending company 102 against later allegations by client 106.

Referring to FIG. 2, the method begins at step 210, where potential client 106 is identified. Potential client 106 may be identified by operator 127 and then added to client list database 156. For example, Interested potential client 106 may call a toll-free telephone number to inquire about insurance policies. Operator 127 uses scripts available from tools database 152 to describe the insurance policies to potential client 106. Tools database 152 may also provide a quote engine that provides an estimated premium payment to potential client 106. Operator 127 may use a preferred providers list in tools database 152 to check whether potential client 106's healthcare provider is covered by the policy. Operator 127 may also use a list of agents matched with potential client 106 generated by evaluation module 134 to select an agent for client 106.

Potential client 106 may also be identified through website 124. For example, interested potential client 106 may access website 124 in order to find out more information about the insurance policies. The website may include, for example, a quote engine, a preferred providers list, and a list of agent profiles available from tools database 152. The website may also include information on how to contact the insurance company, for example, a toll-free telephone number, an email address, or a postal address. A list of upcoming seminars presented by the insurance company may also be posted at the website. Potential client 106 may contact the insurance company using one of the methods suggested by the website, and then may be added to the potential client list in client list database 156.

Potential client 106 may also be identified through seminars presented by the insurance company. The seminars may be advertised, for example, in the media, through contact module 125, or through website 124. Interested potential clients may attend the seminars in order to gather more information about the insurance policies and may leave information on how they may be contacted with a representative at the seminar. Seminar training material may be available from tools database 152. Potential client 106 may also be identified by selecting current clients whose policies will soon expire. These clients may be contacted to renew their policies.

At step 212, agent 104 is matched with client 106. Using the performance records and evaluations of the agents, evaluation module 134 generates a list that matches agents with clients. The list may be generated with information from client list database 156 and agent performance database 154. The list may comprise only the agent who is best matched with the client, or may comprise many agents ranked in order of suitability.

The matching of agents with clients may take into account an agent profile, which includes criteria that describes the agent or his abilities, and a client profile. For example, a highly litigious potential client may be matched with an agent with good client evaluations. The matching order also take into account special situations. For example, a new agent may not have a high ranking on the list because he has not had the time and the experience to sell many policies.

At step 214, monitoring module 132 transmits client information to agent 104, and initiates a clock to time agent 104's response. In one embodiment, agent 104 visits client 106's residence. Agent 104 may bring, for example, a laptop computer that has access to scripts for describing the policies to client 106 and a quote engine, so that agent 104 may give client 106 an estimate of the premium payment. Agent 104 may also use a preferred providers list to determine whether client 106's health service provider is covered by the policy. In one embodiment, agent 104 may fill out the policy at client 106's residence using the laptop. The information known about client 106, for example, his name and address, may already be completed in the form.

Monitoring module 132 receives a response from agent 104 at step 216. Agent 104 may, for example, place a call to company 102 and allow client 106 to talk to agent 104's manager. Additionally, agent 104 may complete a disposition report of the agent-client interaction after leaving client 106's residence to be collected by monitoring module 132. The disposition may include, for example, whether or not client 106 agreed to purchase a policy and the reasons why or why not, and may be stored in client record database 158.

Monitoring module 132 determines whether the agent's response is timely at step 218. The response may be timed from when agent 104 receives the client information to see whether the response is within predetermined period of time. If the response is not timely at step 218, monitoring module 132 triggers an alarm at step 220, such as sending a notification to a manager. The method proceeds to step 222 to ask client 106 about the interaction. If the response is timely at step 218, and the method proceeds to step 222.

Client 106 is asked to about the interaction at step 222. For example, during an agent-client interaction, agent 104 may call his manager. The manager may ask client 106 about the agent-client interaction. The manager may also ask client 106 whether he understands the policy and whether he complies with its terms.

Additionally, monitoring module 132 may ask about the interaction after the interaction using, for example, a written correspondence, an email, or by a script delivered through a telephone call by operator 127. A questionnaire may include standard questions about agent 104's performance and about client 106's understanding of and compliance with the terms of the insurance policies. The answer options may be presented in a manner that is easy to evaluate, for example, ranked multiple choice answer options. The questionnaire may also include questions that may be answered in a free-form format.

At step 224, monitoring module 132 stores client 106's responses in client record database 158. In one embodiment, the responses may be recorded by, for example, recording client 106's telephone call or storing client 106's email message or written correspondence. Client record database 158 may be useful in defending company 102 against client 106's later allegations.

At step 226, client 106's responses are compared with agent 104's report stored in client record database 158. Discrepancies between the responses and the report may indicate client 106's lack of understanding, a miscommunication between agent 104 and client 106, or dishonesty on the part of agent 104.

If there is an actionable discrepancy revealed by the comparison at step 228, a responsive action is taken at step 230. For example, if client 106 responds that he did not purchase a policy, and agent 104 reports that the policy was purchased, monitoring module 132 sends a notification to company 102 to cancel the policy and to stop payment on any commission advance to agent 104. If client 106 responds that agent 104 stole something from client 106's residence or exhibited other egregious misconduct, monitoring module sends an alarm to company 102 to investigate the matter so that further incidences of such conduct can be immediately prevented. After the responsive action is taken, the method proceeds to step 232 to initiate follow up procedures. If there are no actionable discrepancies at step 228, the method proceeds to step 232.

At step 232, follow up procedures are initiated by monitoring module 132 to gather information. Follow up procedures may include, for example, having a health care professional such as a nurse call on client 106. The frequency of follow ups may be based on the experience of agent 104. For example, all interactions of a new agent may be followed up, while only a sample of the interactions of an experienced agent may be followed up.

At step 234, a nurse is informed by monitoring module 132 of visit or call client 106. Monitoring module 132 may, for example, send an email to the nurse. In one embodiment, a nurse is sent to visit client 106 to conduct an interview and an examination. The nurse may ask client 106 about the agent-client interaction, and may also ask questions to generate marketing data. He may also check the health of client 106 by, for example, taking the blood pressure of client 106, and may also test the cognitive abilities of client 106. Results, which are recorded in a nurse report, of the examination may determine whether the client is capable of understanding and complying with an insurance policy. At step 236, monitoring module 132 receives the nurse report and stores the report in client record database 158.

At step 238, delivery of the policy is determined. After the policy has been sent out for delivery, contact module 125 contacts client 106 to confirm that client 106 has received the policy. Operator 127 may ask questions to determine whether client 106 understands and complies with the policy. Additionally, client's 106 confirmation of receipt of the policy may trigger the statutory “free look” period. If delivery is not confirmed at step 238, monitoring module notifies company 102 at step 240 and then proceeds to step 242. If delivery is confirmed, the method proceeds to step 242.

At step 242, agent 104 is evaluated. According to one embodiment, based upon the agent 104's performance as monitored by monitoring module 132, agent 104 is evaluated by evaluating module 134 and may be placed in a ranking order with other agents of company 102. Evaluating module 134 may use the information in agent performance database 154 and client record database 158 to evaluate agent 104. The ranking order may be determined on demand, using agent 104's most recent performance evaluation, on an office website.

At step 244, the results from the follow up are reported. The results may be reported to evaluation module 134 for further processing and may be stored in client record database 158. After the results are reported, the method terminates.

A technical advantage of the present invention is that it continuously gathers and evaluates client feedback about agent-client interactions. The feedback may be used to generate an updated list of agents matched with clients. The feedback may also be used to provide a current assessment of the risks posed by an agent and to determine a premium payment to insure the agent for future transactions. Another technical advantage of the present invention is that it may be used to certify a company to indicate to consumers that the company's agents are being monitored and that clients have a communication channel through which to provide feedback about the agents.

Although an embodiment of the invention and its advantages are described in detail, a person skilled in the art could make various alternations, additions, and omissions without departing from the spirit and scope of the present invention as defined by the appended claims.

What is claimed is:

1. A method for monitoring a service transaction, the method comprising:
communicating with a client through a communication channel;
gathering feedback from the client about an agent and an interaction associated with the agent through the communication channel; and
storing the feedback in a client response database.

2. The method of claim 1, wherein:
gathering comprises gathering the feedback through a telephone call; and
storing comprises recording the telephone call and storing the recorded telephone call.

3. The method of claim 1, further comprising:
receiving an agent report from the agent, the agent report describing the interaction;
determining whether there is an actionable discrepancy between the agent report and the feedback; and
initiating a responsive action if there is the actionable discrepancy.

4. The method of claim 1, further comprising:
determining whether the feedback comprises a trigger event; and
triggering an alarm if the feedback comprises the trigger event.

5. The method of claim 1, further comprising:
generating an evaluation of the agent using the feedback.

6. The method of claim 1, further comprising:
generating an evaluation of the agent using the feedback; and
matching the agent with a second client according to the evaluation.

7. A system for monitoring a service transaction, the system comprising:
a communication channel operable to communicate feedback from a client, the feedback describing an interaction between an agent and the client;
a monitoring module coupled to the communication channel and operable to:
initiate collection of the feedback;
receive the feedback from the communication channel; and
store the feedback in a client record database coupled to the monitoring module.

8. The system of claim 7, wherein the communication channel comprises a website operable to be accessed by the client.

9. The system of claim 7, wherein:
the feedback is gathered through a telephone call; and
the monitoring module is operable to record the telephone call.

10. The system of claim 7, wherein the monitoring module is operable to:
receive an agent report from the agent, the agent report describing the interaction;
determine whether there is an actionable discrepancy between the agent report and the feedback; and
initiate a responsive action if there is the actionable discrepancy.

11. The system of claim 7, wherein the monitoring module is operable to:
determine whether the feedback comprises a trigger event; and
trigger an alarm if the feedback comprises the trigger event.

12. The system of claim 7, further comprising an evaluation module operable to:
generate an evaluation of the agent using the feedback.

13. The system of claim 7, further comprising an evaluation module operable to:
generate an evaluation of the agent using the feedback; and
match the agent with a second client according to the evaluation.

14. Software for monitoring a service transaction, the software residing on a computer-readable medium and operable to:
communicating with a client through a communication channel;
gathering feedback from the client about an agent and an interaction associated with the agent through the communication channel; and
storing the feedback in a client response database.

15. The method of claim 14, wherein:
gathering comprises gathering the feedback through a telephone call; and
storing comprises recording the telephone call and storing the recorded telephone call.

16. The method of claim 14, further comprising:
receiving an agent report from the agent, the agent report describing the interaction;
determining whether there is an actionable discrepancy between the agent report and the feedback; and
initiating a responsive action if there is the actionable discrepancy.

17. The method of claim 14, further comprising:
determining whether the feedback comprises a trigger event; and
triggering an alarm if the feedback comprises the trigger event.

18. The method of claim 14, further comprising generating an evaluation of the agent using the feedback.

19. The method of claim 14, further comprising:
generating an evaluation of the agent using the feedback; and
matching the agent with a second client according to the evaluation.

20. A system for monitoring a service transaction, the system comprising:
a communication channel operable to communicate feedback from a client, the feedback comprising a telephone call describing an interaction between an agent and the client;
a monitoring module coupled to the communication channel and operable to:
initiate collection of the feedback;
receive the feedback from the communication channel;
record the telephone call and store the feedback in a client record database coupled to the monitoring module;
determine whether the feedback comprises a trigger event and trigger an alarm if the feedback comprises the trigger event;
receive an agent report from the agent, determine whether there is an actionable discrepancy between the agent report and the feedback, and initiate a responsive action if there is the actionable discrepancy; and
an evaluation module operable to:
generate an evaluation of the agent using the feedback; and
match the agent with a second client according to the evaluation.
